(19) United States
(12) Patent Application Publication
(10) Pub. No.: US 2011/0128570 A1
(43) Pub. Date: Jun. 2, 2011

(54) IMAGE FORMING APPARATUS AND DOCUMENT DATA MANAGEMENT METHOD THEREOF

(76) Inventors: Ju-ho EUM, Anyang-si (KR); Soo-jin Ji, Anyang-si (KR)

(21) Appl. No.: 12/888,812

(22) Filed: Sep. 23, 2010

(30) Foreign Application Priority Data
Nov. 30, 2009 (KR) 2009-0117199

(51) Int. Cl. G06F 3/12

(52) U.S. Cl. 358/1.15; 358/1.16

(57) ABSTRACT

A document data management method of an image forming apparatus which is connected to at least one external device by using an IPv6 address which includes receiving the document data from the image forming apparatus, determining whether to assign an IPv6 address to the received document data, assigning a corresponding IPv6 address to the document data, adding the document data information and the corresponding assigned IPv6 address to an IPv6 address information table, and storing the document data in the image forming apparatus, wherein the IPv6 address information table includes storage information of the document data and the assigned IPv6 address information.

### CROSS-REFERENCE TO RELATED APPLICATIONS

This application claims priority under 35 U.S.C. §119(a) from Korean Patent Application No. 10-2009-0117199, filed on Nov. 30, 2009 in the Korean Intellectual Property Office, the disclosure of which is incorporated herein in its entirety by reference.

### BACKGROUND

1. Field of the Invention

Exemplary embodiments of the present general inventive concept relate to an image forming apparatus and a document data management method thereof, and more particularly, to an image forming apparatus and a document data management method thereof which stores and manages document data by using an IPv6 address.

2. Description of the Related Art

An image forming apparatus forms an image on a document. The image forming apparatus may include a printer, a photocopier, a facsimile, a multi-function device which has at least two functions, etc.

Recently, demand for an image forming apparatus as an office automation device to perform not only a document print function but also a scanning function and a faxing function has increased. Accordingly, an image forming apparatus has been developed to provide extended functions with high performance.

The image forming apparatus which provides a scan function scans a target document by a copy command, a scan command, and a fax transmission command to generate scan data and stores and manages the generated scan data.

Generally, the scan data is stored and managed in a storage unit provided inside or outside of the image forming apparatus by a scan-to-HDD function or a scan-to-USB function or the generated scan data is transmitted to a designated receiver by a scan-to-email function or a scan-to-server function or a scan-to-host function.

The scan data which is stored inside of the image forming apparatus may be shared with other users through a Web service function supported by the image forming apparatus. A user may access the stored scan data by using a file name of the scan data.

However, to use the Web service function as discussed above, the image forming apparatus should have application middleware therein. Also, an additional search process should be performed to identify desired data among various scan data.

Further, if the scan data is transmitted to the designated receiver, it is difficult for other users to access the transmitted scan data. To access the scan data, the scan data should be retransmitted or shared.

### SUMMARY

Exemplary embodiments of the present general inventive concept provide an image forming apparatus and a document data management method thereof which assigns an IPv6 address to document data including scan data, and identifies and manages the document data through the assigned IPv6 address to thereby easily access or utilize the document data without an additional Web service function or an external transmission process.

Exemplary embodiments of the present general inventive concept may also provide an image forming apparatus and a document data management method thereof which enables easy access and use of document data by searching a location of the document data by using an IPv6 address information table mapping an assigned IPv6 address.

Additional aspects and/or utilities of the present general inventive concept will be set forth in part in the description which follows and, in part, will be obvious from the description, or may be learned by practice of the general inventive concept.

The foregoing and/or other features and utilities may be achieved by providing a document data management method of an image forming apparatus which is connected to at least one external device by using an IPv6 address, the method includes receiving the document data from the image forming apparatus, determining whether to assign an IPv6 address to the received document data, assigning a corresponding IPv6 address to the document data, adding the document data information and the assigned IPv6 address to an IPv6 address information table, and storing the document data in the image forming apparatus, wherein the IPv6 address information table includes storage information of the document data and the assigned IPv6 address information.

The method may further include determining whether the IPv6 address information table exists.

The receiving the document data may include receiving at least one of scan data scanned and generated by the image forming apparatus, fax data received from a fax machine, print data transmitted from at least one external device and email and scan data.

The method may further include providing the IPv6 address information, wherein the providing the IPv6 address information includes displaying the assigned IPv6 address information on a first display unit of the image forming apparatus or on a second display unit of at least one external device connected to the image forming apparatus.

The displaying the assigned IPv6 address information on the second display unit may include using an exclusive application between the image forming apparatus and the external device or email.

The displaying may include searching from the at least one external device the document data stored in the image forming apparatus by using the provided IPv6 address information.

The provided IPv6 address information may include the IPv6 address information table.

The method may further include transferring a storage location of the stored document data, reassigning an IPv6 address to the document data transferred, and updating the reassigned IPv6 address information to the IPv6 address information table.

The transferring the storage location of the document data may include storing the document data in another storage location of the image forming apparatus or storing the document data in another image forming apparatus.

The method may further include determining whether the IPv6 address information received is the IPv6 address information assigned to the stored document data if the document data stored in the image forming apparatus are searched by using the IPv6 address information.

The foregoing and/or other features and utilities of the present general inventive concept may also be achieved by providing an image forming apparatus, including a communication unit which is connected to at least one external device through an IPv6 address, a storage unit to store therein document data and a controller to determine whether to assign an IPv6 address to document data upon reception of the document data from the image forming apparatus, to assign the IPv6 address corresponding to the document data, to add the document data information and the assigned IPv6 address to an IPv6 address information table, and to store the document data in the storage unit.

The controller may determine whether the IPv6 address information table exists.

The image forming apparatus may further include an image scanner which scans a document and generates scan data, wherein the received document data may include at least one of scan data scanned and generated by the image scanner, fax data received from a fax machine, print data transmitted from at least one external device, and email and scan data.

The image forming apparatus may further include a display unit to display the assigned IPv6 address information.

The communication unit may transmit the assigned IPv6 address information to the external device by using an exclusive application between the image forming apparatus and the external device or email.

The document data stored in the image forming apparatus may be searched from at least one external device through the provided IPv6 address information.

The provided IPv6 address information may include the IPv6 address information table.

The image forming apparatus may further include a user input unit which receives a command to transfer a storage location of the stored document data, wherein the controller may reassign an IPv6 address to the document data transferred, and update the reassigned IPv6 address information to the IPv6 address information table.

The command to transfer the storage location may include a command to store the document data in another storage location within the image forming apparatus or to another image forming apparatus.

The controller may determine whether the received IPv6 address information is the IPv6 address information assigned to the stored document data if the document data stored in the image forming apparatus is searched by using the iPv6 address information.

The foregoing and/or other features and utilities of the present general inventive concept may also be achieved by providing a method of managing data of an image forming apparatus which includes assigning an IPv6 address to data generated by the image forming apparatus, storing the data to a storage unit, and generating an information table of the data which includes the assigned IPv6 address and storage location information.

The method may include storing the information table within the storage unit.

The method may further include notifying a user of the assigned IPv6 address corresponding to the data.

The method may further include searching for the data based on the assigned IPv6 address.

The method may further include setting a time period during which the stored data can by retrieved by using the assigned IPv6 address.

The storage location information may include a physical address of the stored data.

The foregoing and/or other features and utilities of the present general inventive concept may also be achieved by providing a recording medium having recorded thereon a program to cause a computer system to perform operations in a method of managing document data, the method includes assigning an IPv6 address to document data generated by an image forming apparatus, storing the document data to a storage unit, and generating an information table of the document data which includes the assigned IPv6 address and storage location information.

### BRIEF DESCRIPTION OF THE DRAWINGS

The above and/or other features and utilities will become apparent and more readily appreciated from the following description of the exemplary embodiments, taken in conjunction with the accompanying drawings, in which:

FIG. 1 is a block diagram of an image forming apparatus according to an exemplary embodiment of the present general inventive concept;

FIG. 2 is a flowchart of a document data storage process according to an exemplary embodiment of the present general inventive concept;

FIG. 3 is a flowchart of a document data search process which uses an IPv6 address according to an exemplary embodiment of the present general inventive concept; and

FIG. 4 is a flowchart of a document data search process which uses an IPv6 address according to an exemplary embodiment of the present general inventive concept.

### DETAILED DESCRIPTION OF THE EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. The embodiments are described below in order to explain the present general inventive concept by referring to the figures.

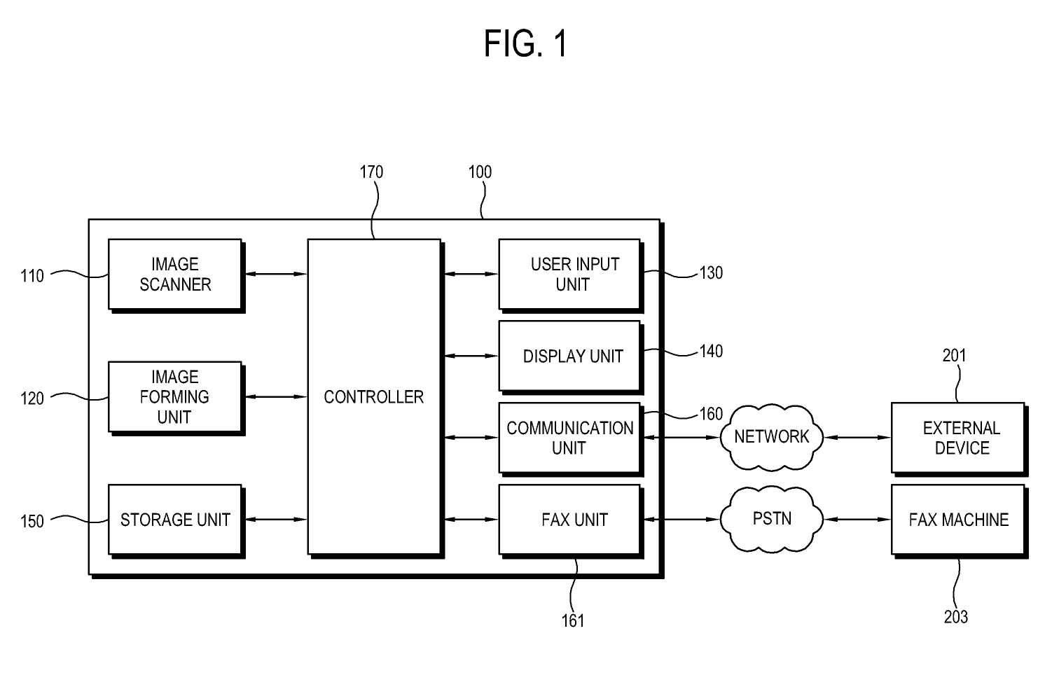

FIG. 1 is a block diagram of an image forming apparatus 100 according to an exemplary embodiment of the present general inventive concept. The image forming apparatus 100 according to the present exemplary embodiment may include a multi-function device having at least two functions out of printing, copying, scanning, and faxing functions or a printer.

As illustrated in FIG. 1, the image forming apparatus 100 according to an exemplary embodiment of the present general inventive concept includes an image scanner 110, an image forming unit 120, a user input unit 130, a display unit 140, a storage unit 150, a communication unit 160, a fax unit 161, and a controller 170.

In exemplary embodiments, the image scanner 110 scans a target document and generates scan data. The target document may include a document, a photo, a film, etc. The image scanner 110 may include a photo converter, such as CCD and CIS, and an image processor which generates an image from a document by using a signal output from the photo converter. The image scanner 110 may further include a scan motor (not illustrated) to drive the photo converter and the image processor and a guide (not illustrated).

The scan data which can be scanned by the image scanner 110 may be changed into a fax signal and transmitted to an external fax machine 203 by the fax unit 161 (to be described below).

The image forming unit 120 can form an image on at least one sheet of paper based on print data and can perform a print operation according to a print command. The print operation includes a print operation of fax data received from the external fax machine 203, a print operation to copy a scanned document, and a print operation of print data received from an external device 201, such as a server and a host device 200 or print data stored in an internal source (i.e., hard disk drive) or an external source (i.e., USB memory stick) of the image forming apparatus 100.

The user input unit 130 can receive a user's command input by various methods, such as via a keyboard, a touch-screen display, etc. The user input unit 130 may include an input button (hereinafter, to be also called “hard key”) provided in the image forming apparatus 100 or a graphic user interface (GUI) (hereinafter, to be also called “UI”) which can be generated by an execution of a program such as an application program and displayed on the display unit 140 to receive a user's input, including input by touch. However, the present general inventive concept is not limited thereto. That is the display unit 140 may receive the user's input via buttons, audio signals, video signals, etc.

A user may perform a log-in process inputting an ID and a password assigned for each user account through the user input unit 130. In exemplary embodiments, the log-in process includes an administrator log-in process in which setting and/or changing of all of the environments of the image forming apparatus 100 may be available without an additional access limit, such as an additional password. If a user log-in process or an administrator log-in process is performed, the image forming apparatus 100 identifies and permits a user to operate the image forming apparatus 100. According to the present general inventive concept, a user includes an administrator.

The display unit 140 can display thereon a setting and an operation status of the image forming apparatus 100, and may display a UI screen to receive various commands from a user. The display unit 140 may include a liquid crystal display (LCD), a driver (not illustrated) to drive the LCD, and a touch panel (hereinafter, to be also called “touch screen” or “touch pad”) to recognize a user's touch. However, the present general inventive concept is not limited thereto. That is, in alternative exemplary embodiments, the display unit 140 may include image and/or audio recognition applications to recognize an input by the user. For instance, the user may speak a desired input command into the display unit 140.

In the image forming apparatus 100 according to the present exemplary embodiment, the user input unit 130 may include an icon to be selected by a user through a touch panel of the display unit 140. In exemplary embodiments, the user input unit 130 and the display unit 140 may be provided as a single configuration rather than separate configurations. That is, in exemplary embodiments, the user input unit 130 and the display unit 140 may be combined into a single device.

In the image forming apparatus 100 according to the present exemplary embodiment, the single configuration of the user input unit 130 and the display unit 140 is also called an operation panel equipment (OPE).

The display unit 140 may include a first display unit 142 which is provided in the image forming apparatus 100, and a second display unit 144 which is provided in the external device 201 and connected with the image forming apparatus 100 through the communication unit 160.

In exemplary embodiments, when the display unit 140 includes the second display unit 144, a remote user interface is selected as the user input unit 130 displayed on the second display unit 144. A user's input command can be received from the external device 201, such as through the host device 201 connected to the image forming apparatus 100 via the communication unit 160. However, the present general inventive concept is not limited thereto.

The storage unit 150 may store therein various print data for a print operation, fax data for a fax transmission, scan data scanned by the image scanner 110, data received from the external device 201 connected through the communication unit 160, various setting information of the image forming apparatus 100 through the user input unit 130, user registration information set for each user account, user certification information, usage authorization information, etc.

The document data according to the present exemplary embodiment may include at least one of scan data scanned and/or generated by the image forming apparatus 100, fax data received from the external fax machine 203, print data transmitted from at least one external device 201, and email and scan data.

The storage unit 150 includes an internal storage medium, such as an HDD 151, or an external or portable storage medium such as a USB memory 152, a memory card (memory stick, CF card, and a MMC), and a memory card slot.

The storage unit 150 may further include an IPv6 address information table which includes an IPv6 address assigned to stored document data and storage information of the document data (e.g., storage location information).

The communication unit 160 performs a data communication with a host apparatus or the external device 201 including a server connected in a wired or wireless network, and may receive print data in a predetermined print language from an external source.

The communication unit 160 may include a wired or wireless network communication module which is connected with the external device 201, such as a host device connected via a local connection or in a network by a predetermined protocol, or an interface (e.g., USB port) connected to a portable storage medium, such as a USB memory or an interface which is connected to the HDD 151.

The fax unit 161 may include a fax communication module (e.g., modem) which converts image data generated by the image scanner 110 into a fax signal and may transmit the fax signal to an external fax machine 203 (including a multi-function device having a fax function) by using a public switched telephone network (PSTN) or may receive a fax signal from the external fax machine 203.

In exemplary embodiments, data which is received from the external device through the communication unit 160 and the fax unit 161 (including fax data) can be stored in the storage unit 150.

The communication unit 160 includes a network interface card (NIC) which uses an IPv6, i.e., an IPv6 address according to IPv6.

IPv6 is an improved version of IPv4 which has 4.2 billion addresses in 32-bit address system. IPv6 has a 128-bit address system including a 64-bit routing address area and a 64-bit automatic address generating area, and may use up to 1 trillion addresses.

According to an automatic configuration function, out of the 128-bit address information, the first 64-bit may be used as inherent address for routing and the remaining 64-bit may be determined according to requirements of a network. The IP address according to IPv6 may be indicated as a block by 16 bit.

IPv4 has a single IP address assigned to a single NIC, while IPv6 has a plurality of IP addresses used in a single NIC. In exemplary embodiments, the image forming apparatus 100, which includes NIC supporting IPv6, may assign different IP addresses corresponding to a plurality of elements.

According to the present exemplary embodiment, the IPv6 address can be assigned to each of the scan data generated by the image scanner 110 and the scan data assigned with the IPv6 address can be stored in the storage unit 150. A user may access the scan data stored in the storage unit 150 through the communication unit 160 by using the assigned IP address from the external device 201, and may also read and/or download the scan data. However, the present general inventive concept is not limited thereto. That is, in exemplary embodiments, the user may read and write to the scan data stored in the storage unit 150 which was accessed by using the assigned IP address.

In exemplary embodiments, the image forming apparatus 100 may assign an IPv6 address to, and store, fax data received from the fax machine 203, print data transmitted from at least one external device 201, document data including email and scan data as well as the scan data generated by the image forming apparatus 100, and may access the document data by using the assigned IPv6 address from the external device 201.

IPv6 may secure different bandwidths according to services with respect to IPv4 and may provide a more reinforced or secure security function by supporting flawless and confidential data to thereby provide real-time service which requires quality of service. As addresses are assigned by unicast, anicast, and multicast instead of by class, the assigned addresses are not wasted.

In exemplary embodiments, layers according to IPv6, i.e., an application layer in a layer model, may correspond to an application layer of existing OSI 7 layer, a presentation layer, and/or a session layer including telnet, ftp and http. However, the present general inventive concept is not limited thereto.

The image forming apparatus 100 according to the present exemplary embodiment may search an available IPv6 address when storing document data including scan data in the storage unit 150 such as an HDD 151, and may create an IPv6 address information table which matches the searched IPv6 address and a storage location of the document data (e.g., a physical address of an HDD). The IPv6 address information table may be managed by an MFP data manager of the application layer.

In exemplary embodiments, the controller 170 may control an entire operation of the image forming apparatus 100. The controller 170 may include an MFP data manger as an application to assign an IP address to document data and to manage the IP address table 151.

The controller 170 can assign an IPv6 address to document data and can store the document data in the storage unit 150.

The controller 170 may control the image scanner 110 to scan a document according to a scan command and generate scan data, and to store the generated scan data in the storage unit 150 by assigning an IPv6 address to the scan data.

The controller 170 may receive fax data from the fax machine 203, print data from at least one external device 201 and email and scan data, assign an IPv6 address to the received document data, and store the data in the storage unit 150.

The assigned IP address may include eight 16-bit blocks, such as 1080:0:0:0:8:800:200C:417A. The controller 170 may set the assigned IPv6 address as a file name of the document data.

The controller 170 may control the display unit 140 to display thereon a UI asking a user whether to assign an IPv6 address to document data and to input a user's selection through the user input unit 130 corresponding to the display unit 140.

If a user selects to assign the IPv6 address to the document data, the controller 170 determines an assignment of the IPv6 address and can control the display unit 140 to display a determination thereon. Determining whether to assign the IPv6 address includes determining whether there exists any assignable IPv6 address and/or validating whether an IPv6 address is usable.

Depending on the usability of the IPv6 address, the controller 170 may assign the IPv6 address to the document data and stores the document data and the corresponding IPv6 address in the storage unit 150.

In exemplary embodiments, the controller 170 may control the storage information of the stored document data (i.e., a physical address) in association with the assigned Ipv6 address.

More specifically, the controller 170 may update the storage information of the document data and the assigned Ipv6 address in a pre-stored Ipv6 address information table 151. If the prestored Ipv6 address information table does not exist, the controller 170 may generate an Ipv6 address information table including the storage information of the document data and the assigned Ipv6 address information.

Table 1 illustrates an IPv6 address information table according to an exemplary embodiment of the present general inventive concept.

TABLE 1

| | | | Location of | Life |
|---|---|---|---|---|
| Num | IP Address | Next Hop | File System | Time |
| 1 | 1080:0:0:0:8:800:200C:417A | 1080:0:0:0:8:400:400C:817A | 0x867534556 | 3 days |
| 2 | | | | |
| 3 | | | | |

As illustrated in Table 1, the IPv6 address information table illustrates the assigned IP address information, location information within a physical file system such as an HDD, and life time information of the IP address. However, the present general inventive concept is not limited thereto. That is, in exemplary embodiments, the IPv6 address information table may include other information, such as a user ID, a time stamp, a file size, etc.

A user may set the life time of the IPv6 address assigned to the document data. IPv6 address space may be up to one trillion addresses but using too many IP addresses for a single image forming apparatus 100 may be an inefficient use of resources. Thus, the image forming apparatus 100 according to an exemplary embodiment of the present general inventive concept may set a life time of the assigned IPv6 address and use the assigned IPv6 address during the set life time.

After the assigned life time is over, access to the document data is not possible with the Ipv6 address, however, the document data itself may not removed.

The controller 170 may control the display unit 140 to display thereon a UI for a user to select the life time of the IPv6 address. In exemplary embodiments, the life time of the IPv6 address may be set as three days, as in Table 1. However, the present general inventive concept is not limited thereto. That is, in alternative exemplary embodiments, the life time of the IPv6 address may be set to a desired period of time by the user.

The controller 170 updates the IPv6 address information, storage information, and set life time information of new document data stored in the storage unit 150 to the prestored IPv6 address information table.

When the assignment and storage of the Ipv6 address of the document data and the update of the IPv6 address information table is complete, the controller 170 may notify a user of the foregoing through an exclusive application program between the image forming apparatus 100 and the external device 201 or email. The notified information may include the assigned Ipv6 address information. If a file name of the document data is an IPv6 address, the notified information may also include file name information.

A user may access the document data stored in the image forming apparatus 100 through the notified IPv6 address and may download the document data. A user may request an access to the document data through the IPv6 address by using the external device 201, such as a PC including a host apparatus. A user may request access to the document data through an exclusive application program between the image forming apparatus 100 and the external device 201.

More specifically, in exemplary embodiments, the external device 201 transmits a packet including the IPv6 address information to the image forming apparatus 100, and the controller 170 controls the communication unit 160 to receive the packet, including the IPv6 address information transmitted from the external device 201.

While the packet received to the image forming apparatus 100 passes through each layer of the OSI mode in a reverse order, headers may be sequentially removed and the packet arrives at an application layer. The controller 170 may determine whether the IP address of the packet, whose header is removed and encapsulated, is the IPv6 address assigned to the stored document data.

If it is determined that the IPv6 address of the packet is assigned to the document data, the controller 170 may search the IPv6 address information table, such as Table 1, and transmit the document data to the external device 201 by using the storage information of the document data (physical address) corresponding to the IPv6 address according to the search result.

The controller 170 may call an address of the external device 201 to transmit the document data and may transmit the document data to the external device 201 by using Transmission Control Protocol (TCP) or User Datagram Protocol (UDP). However, the present general inventive concept is not limited thereto. That is, in exemplary embodiments, Stream Control Transmission Protocol (SCTP) and Datagram Congestion Control Protocol (DCCP) may also be used to transmit the document data to the external device 201.

A user may transfer a storage location of the document data stored in the image forming apparatus 100 to another image forming apparatus by using the external device 201 or through a network communication function of the image forming apparatus 100.

More specifically, the document data stored in the image forming apparatus 100 may have the storage location changed to another image forming apparatus through data transmission (1. Data Transfer). The image forming apparatus 100 which initially stores the document data is called a first image forming apparatus while the image forming apparatus which receives the document data from the first image forming apparatus is called a second image forming apparatus.

In exemplary embodiments, the second image forming apparatus 100′ may reassign a new IPv6 address to and store the document data received from the first image forming apparatus, and may update the Ipv6 address information table.

The second image forming apparatus may transmit the reassigned IPv6 address information to the first image forming apparatus.

The first image forming apparatus may update the IPv6 address information table with the reassigned IPv6 “Next Hop,” as illustrated in Table 1.

Then, the first image forming apparatus may receive a packet including the IP address information from the external device 201 (2. Data Access). The first image forming apparatus may determine whether the IP address of the received packet is the IPv6 address assigned to the stored document data. If it is determined that the IP address of the packet is assigned to the document data, the first image forming apparatus searches the IPv6 address information table.

The first image forming apparatus may search the IPv6 address information table and may determine whether to change the storage location of the document data corresponding to the IP address. If the IPv6 address information table includes the changed “Next Hop” data with respect to the IP address, the first image forming apparatus notifies the external device 201 of necessity for re-access together with transmission of new IP address information of the document data (3. Data Redirect).

The external device 201 may access through the new IP address the second image forming apparatus to which the document data are transferred and download the document data (4. Data communication).

The image forming apparatus 100 according to the present general inventive concept may reassign the IPv6 address, add the reassigned IPv6 address and search and download the document data even when the document data are transferred to another location within the same image forming apparatus 100, as well as when the document data are transferred to another image forming apparatus.

Accordingly, the image forming apparatus 100 according to the present general inventive concept may assign the IPv6 address to, and store, the scan data generated by a scan process, print data received from the outside, fax data, and document data including email, and transmit and receive data through the assigned IPv6 address to enable a user to manage document data more conveniently.

The image forming apparatus 100 according to the present general inventive concept notifies a user of the assigned IPv6 address through email or an exclusive application, and an outside uses only the notified IPv6 address to access the document data. Thus, security for the document data is further reinforced.

Even when the storage location of the document data is changed, a user may access the desired data through the IPv6 address information table.

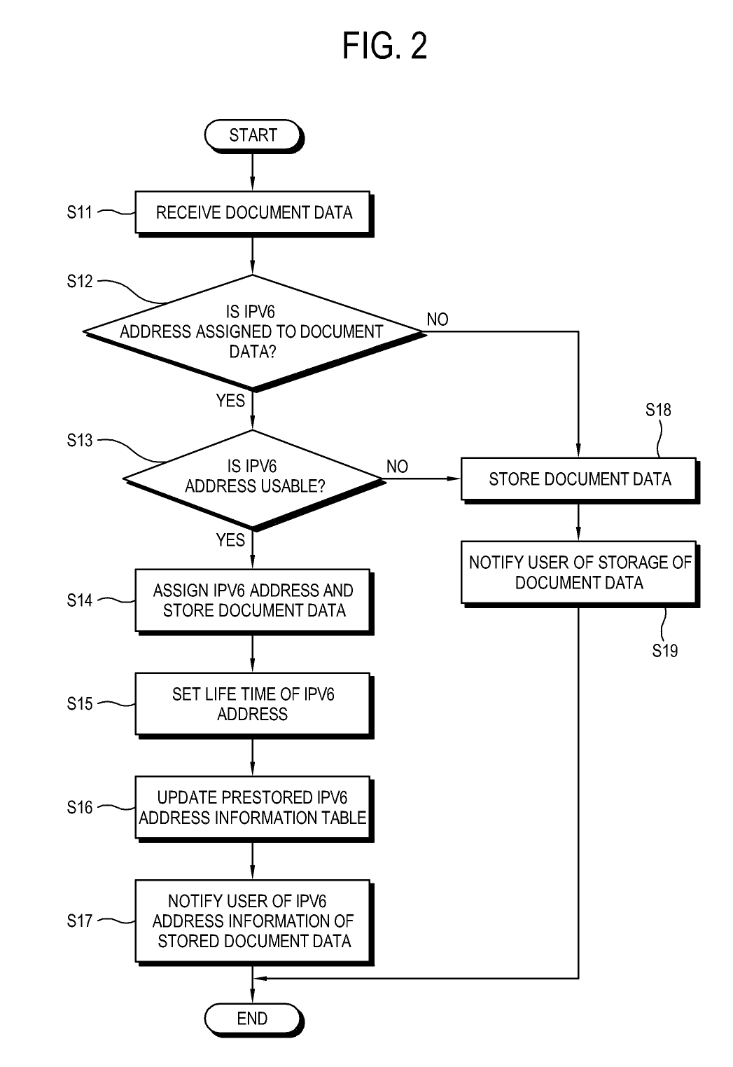

With the foregoing configuration, a document data management method of the image forming apparatus 100 will be described with reference to FIGS. 2 to 4.

FIG. 2 is a flowchart of a document data storage process according to an exemplary embodiment of the present general inventive concept.

As illustrated therein, the image forming apparatus 100 receives the document data (S11). The image forming apparatus 100 may receive at least one of the scan data scanned and generated by the image scanner 110, the fax data received from the fax machine 203, the print data transmitted from at least one external device 201 and the email and scan data.

A user may select whether to assign the IPv6 address to the received document data (S12). The controller 170 may generate and display a UI on the display unit 140 and receive a user's selection whether to assign the IP address to the received document data.

If a user selects to assign the IPv6 address at operation S12, the controller 170 determines whether the IPv6 address is available (S13). The controller 170 may determine whether there is any available IP address or may validate the existing IP address and determine whether it is usable.

The image forming apparatus 100 according to the present general inventive concept may perform at least one operation of operations S12 and S13 and may determine whether to assign the IPv6 address corresponding to the received document data.

If it is determined at operation S13 that the available IPv6 address is usable, the controller 170 assigns the IPv6 address and stores the document data received at operation S11 in the storage unit 150 (S14).

In exemplary embodiments, a user may set a life time of the IPv6 address assigned to the document data (S15). The controller 170 may generate and display a UI on the display unit 140 so that a user may select the life time of the IP address from the displayed UI through the user input unit 130.

The controller 170 adds the IPv6 address assigned at operation S14 and the storage information of the scan data (physical address) and the life time information set at operation S15 to the IPv6 address information table together with the document data information (S16). The controller 170 may determine whether there is the IPv6 address information table and update the prestored IPv6 address information table or may generate a new IPv6 address information table.

The controller 170 may notify a user of the IPv6 address information assigned at operation S14 through email or an exclusive application program (S17). More specifically, the IPv6 address information may be displayed on the first display unit 120 of the image forming apparatus 100 or on a second display unit of at least one external device 201 connected to the image forming apparatus 100, and the provided IPv6 address information may include the IPv6 address information table.

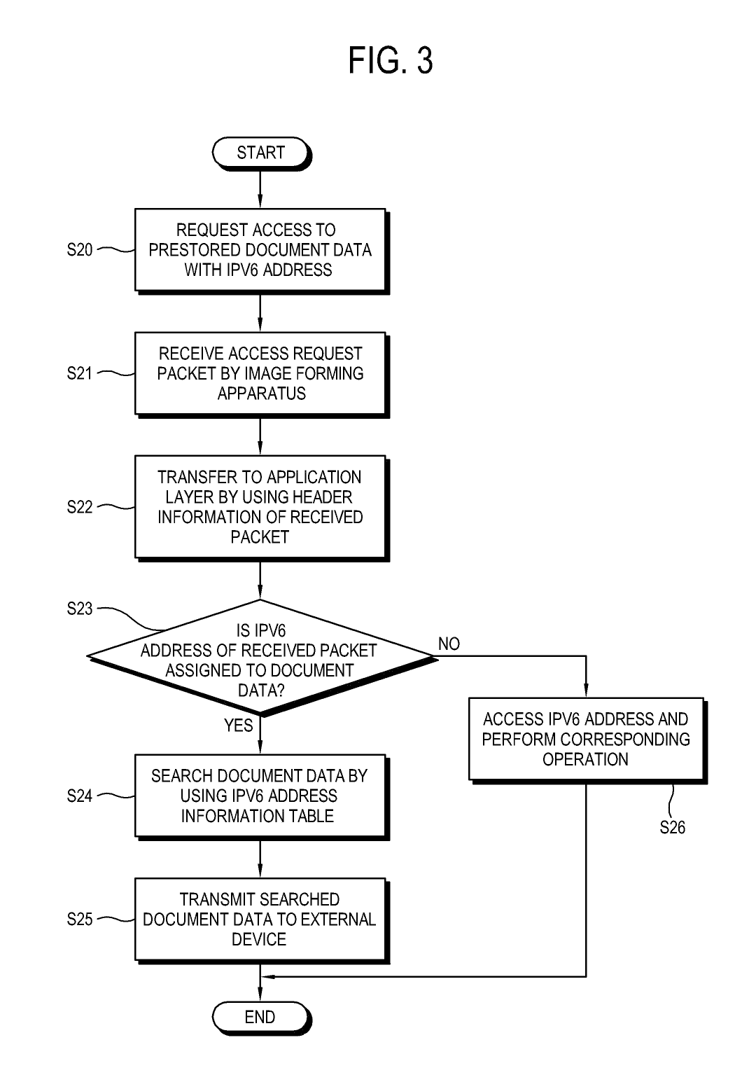

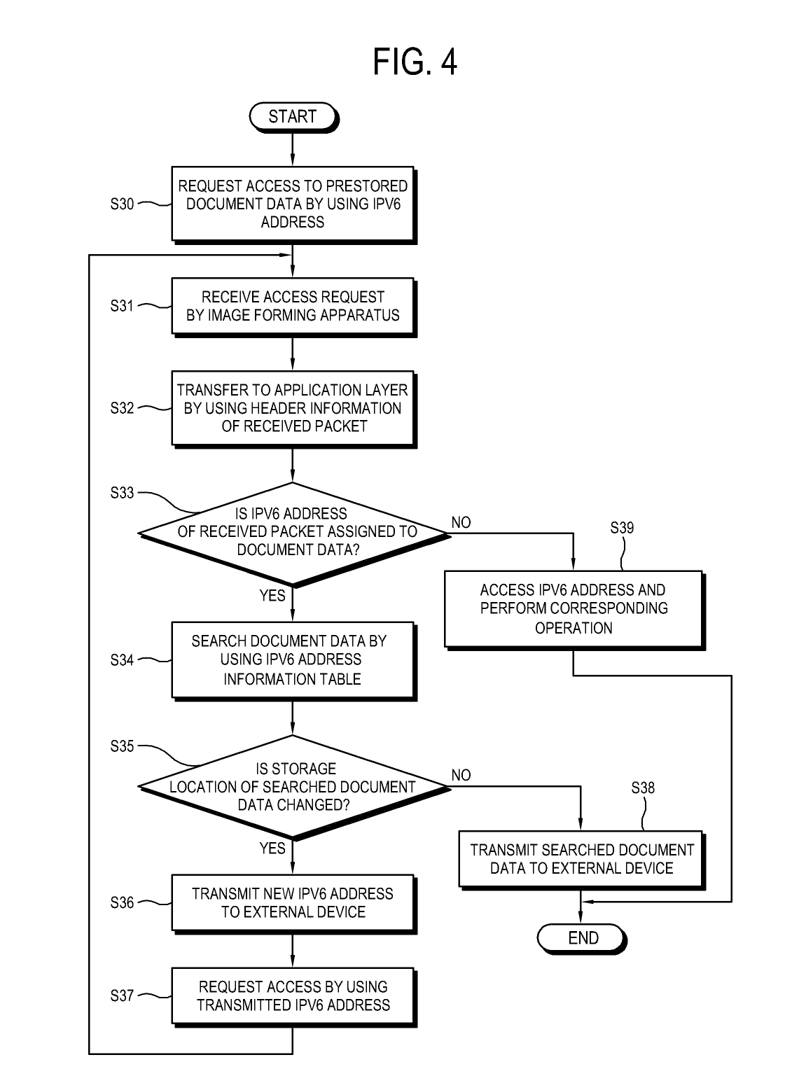

A user may access and download the document data stored in the image forming apparatus 100 through the IPv6 address information notified at operation S17 as in FIGS. 3 and 4. A user may search from at least one external device 201 connected to the image forming apparatus 100 for the document data stored in the image forming apparatus 100 through the provided IPv6 address information.

If a user elects not to assign the IP address at operation S12 or it is determined at operation S13 that the IPv6 is not usable, the controller 170 may store the document data in the storage unit 150, without any additional operations (S18).

In exemplary embodiments, the controller 170 may notify a user of the storage of the document data stored at operation S18 (S19).

FIG. 3 is a flowchart of a document data search process by using the IP address according to an exemplary embodiment of the present general inventive concept.

As illustrated therein, a user may request access to the document data stored in the image forming apparatus 100 through the IPv6 address received by the notification at operation S17 (see FIG. 2) from the external device 201, such as a host PC (S20).

The image forming apparatus 100 receives the access request packet including the IPv6 address (S21).

The packet which is received at operation S21 may be transferred from the physical layer to the application layer by using the header information (S22).

The application layer determines whether the IP address of the packet received at operation S21 is the IPv6 address assigned to the document data stored in the image forming apparatus 100 (S23).

If it is determined at operation S23 that the IP address is the IPv6 address assigned to the document data, the controller 170 searches the document data corresponding to the received IPv6 address by using the prestored IPv6 address information table (S24).

The controller 170 transmits the document data searched at operation S24 to the external device 201 through the communication unit 160 (S25). The controller 170 may transmit the search result to the external device 201 and transmit the document data according to the response from the external device 201.

If it is determined at operation S23 that the IP address is not the address assigned to the scan data, the controller 170 may perform a corresponding operation by accessing the received IPv6 address (S26).

FIG. 4 is a flowchart of a scan data transmission and reception process by using the IP address according to another exemplary embodiment of the present general inventive concept.

As illustrated therein, a user may request access to the document data stored in the image forming apparatus 100 by using the IPv6 address received by the notification at operation S17 (see FIG. 2) from the external device 201 such as a PC (S30).

The image forming apparatus 100 receives the access request packet, including the IPv6 address (S31).

The packet which is received at operation S31 may be transferred from the physical layer to the application layer by using the header information (S32).

The application layer determines whether the IP address of the packet received at operation S31 is the IPv6 address assigned to the document data (S33).

If it is determined at operation S33 that the IP address is the IPv6 address assigned to the document data, the controller 170 searches the document data corresponding to the received IPv6 address by using the prestored IPv6 address information table (S34).

According to the search result at operation S34, the controller 170 may detect that the storage location of the document data changes and a new IPv6 address is assigned (S35). Then, a user may not access the document data with the IPv6 address received at operation S31, and the IPv6 address information table includes the reassigned IPv6 address information. The change of the storage location of the document data may refer to a transfer of the document data to another storage location within the same image forming apparatus (i.e., a first image forming apparatus) or a storage location with another image forming apparatus (i.e., a second image forming apparatus).

If it is detected at operation S35 that the storage location of the document data is changed, the controller 170 transmits the IPv6 address information of the IPv6 address information table to the external device 201 (S36).

The external device 201 again requests the access to another location of the document data by using the reassigned IPv6 address information received at operation S36 (S37). If the document data is transferred to another image forming apparatus, the external device 201 may request access to the second image forming apparatus, which has received the document data.

If the storage location of the document data is not changed at operation S35, the controller 171 may transmit the document data searched at operation S34 to the external device 201 through the communication unit 160 (S38). The controller 170 may transmit the search result to the external device 201 and may transmit the document data according to a response from the external device 201.

If it is determined at operation S33 that the IP address is not the IPv6 address assigned to the document data, the controller 170 may perform a corresponding operation by accessing the received IP address (S38).

The image forming apparatus 100 according to the present general inventive concept may assign the IPv6 address to the document data including the scan data, access and download the document data through the assigned IPv6 address, and search a location of the document data even if the storage location of the document data is changed.

As described above, an image forming apparatus and a document data management method thereof according to the present general inventive concept assigns an IPv6 address to document data including scan data, identifies and manages the document data by using the assigned IPv6 address to thereby easily access and utilize the document data without requiring an additional Web service function or an external transmission process.

Also, an image forming apparatus and a document data management method thereof according to the present general inventive concept searches a location of document data by using an IPv6 address information table mapping an assigned IPv6 address even if a storage location of the document data is changed, and enables a user to access and use the document data more conveniently.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A document data management method of an image forming apparatus connectable to at least one external device by using an IPv6 address, the method comprising:
receiving the document data from the image forming apparatus;
determining whether to assign an IPv6 address to the received document data;
assigning a corresponding IPv6 address to the document data;
adding document data information and the assigned IPv6 address to an IPv6 address information table; and
storing the document data in the image forming apparatus,
wherein the IPv6 address information table comprises storage information of the document data and the assigned IPv6 address information.

2. The method according to claim 1, further comprising determining whether the IPv6 address information table exists.

3. The method according to claim 1, wherein the receiving the document data comprises receiving at least one of scan data scanned and generated by the image forming apparatus, fax data received from a fax machine, print data transmitted from at least one external device and email and scan data.

4. The method according to claim 1, further comprising providing the IPv6 address information, wherein the providing the IPv6 address information comprises displaying the assigned IPv6 address information on a first display unit of the image forming apparatus or on a second display unit of at least one external device connected to the image forming apparatus.

5. The method according to claim 4, wherein the displaying the assigned IPv6 address information on the second display unit comprises using an exclusive application between the image forming apparatus and the external device or email.

6. The method according to claim 4, wherein the displaying comprises searching from the at least one external device the document data stored in the image forming apparatus by using the provided IPv6 address information.

7. The method according to claim 4, wherein the provided IPv6 address information comprises the IPv6 address information table.

8. The method according to claim 1, further comprising:
transferring a storage location of the stored document data;
reassigning an IPv6 address to the document data transferred; and
updating the reassigned IPv6 address information to the IPv6 address information table.

9. The method according to claim 8, wherein the transferring the storage location of the document data comprises storing the document data in another storage location of the image forming apparatus or storing the document data in another image forming apparatus.

10. The method according to claim 6, further comprising determining whether the IPv6 address information received is the IPv6 address information assigned to the stored document data if the document data stored in the image forming apparatus are searched by using the IPv6 address information.

11. An image forming apparatus, comprising:
a communication unit which is connected to at least one external device through an IPv6 address;
a storage unit to store document data; and
a controller to determine whether to assign an IPv6 address to document data upon reception of the document data from the image forming apparatus, to assign the IPv6 address corresponding to the document data, to add the document data information and the assigned IPv6 address to an IPv6 address information table and to store the document data in the storage unit.

12. The image forming apparatus according to claim 11, wherein the controller determines whether the IPv6 address information table exists.

13. The image forming apparatus according to claim 11, further comprising an image scanner which scans a document and generates scan data, wherein
the received document data comprise at least one of scan data scanned and generated by the image scanner, fax data received from a fax machine, print data transmitted from at least one external device and email and scan data.

14. The image forming apparatus according to claim 11, further comprising a display unit which provides the assigned IPv6 address information.

15. The image forming apparatus according to claim 14, wherein the communication unit transmits the assigned IPv6 address information to the external device by using an application program between the image forming apparatus and the external device or email.

16. The image forming apparatus according to claim 15, wherein the document data stored in the image forming apparatus is searched from at least one external device through the transmitted IPv6 address information.

17. The image forming apparatus according to claim 14, wherein the provided IPv6 address information comprises the IPv6 address information table.

18. The image forming apparatus according to claim 11, further comprising a user input unit which receives a command to transfer a storage location of the stored document data, wherein
the controller reassigns an IPv6 address to the document data transferred, and updates the reassigned IPv6 address information to the IPv6 address information table.

19. The image forming apparatus according to claim 18, wherein the command to transfer the storage location comprises a command to store the document data in another storage location within the image forming apparatus or to another image forming apparatus.

20. The image forming apparatus according to claim 16, wherein the controller determines whether the received IPv6 address information is the IPv6 address information assigned to the stored document data if the document data stored in the image forming apparatus is searched by using the iPv6 address information.

21. A method of managing data of an image forming apparatus, the method comprising:
assigning an IPv6 address to data generated by the image forming apparatus;
storing the data to a storage unit; and
generating an information table of the data which includes the assigned IPv6 address and storage location information.

22. The method of claim 21, further comprising notifying a user of the assigned IPv6 address corresponding to the data.

23. The method of claim 22, further comprising searching for the data based on the assigned IPv6 address.

24. The method of claim 22, further comprising setting a time period during which the stored data can by retrieved by using the assigned IPv6 address.
